(19) United States
(12) Patent Application Publication
(10) Pub. No.: US 2013/0323624 A1
(43) Pub. Date: Dec. 5, 2013

(54) ELECTROCATALYST FOR A FUEL CELL AND THE METHOD OF PREPARING THEREOF

(71) Applicant: NANO AND ADVANCED MATERIALS INSTITUTE LIMITED, Clear Water Bay (HK)

(72) Inventors: Hongjuan Wang, Clear Water Bay (HK); Feng Peng, Clear Water Bay (HK); Hao Yu, Clear Water Bay (HK); Jiadao Zheng, Clear Water Bay (HK)

(73) Assignee: NANO AND ADVANCED MATERIALS INSTITUTE LIMITED, Clear Water Bay (HK)

(21) Appl. No.: 13/783,456

(22) Filed: Mar. 4, 2013

Related U.S. Application Data
(60) Provisional application No. 61/689,174, filed on May 31, 2012.

(51) Int. Cl. H01M 4/92; H01M 4/88; H01M 4/86

(52) U.S. Cl. CPC H01M 4/926; H01M 4/8657; H01M 4/8825; H01M 4/8892; H01M 4/8663
USPC 429/524; 429/523; 429/532; 427/115; 427/113

(57) ABSTRACT

The invention relates to an electrocatalyst for a fuel cell comprising carbon nanotubes as substrate, ruthenium oxide deposited on the substrate, platinum particles supported on the ruthenium oxide, and manganese dioxide layer coated on the surface of the ruthenium oxide-platinum particles deposited carbon nanotubes. The invention also relates to the method of preparing the electrocatalyst for a fuel cell comprising the steps of depositing ruthenium oxide on the surface of carbon nanotubes, depositing platinum particles on the ruthenium oxide, and coating a manganese dioxide layer on the surface of the ruthenium oxide-platinum particles deposited carbon nanotubes.

### FIELD OF THE INVENTION

The present invention relates to an electrocatalyst for use in a fuel cell, and particularly, but not exclusively, to an anode electrocatalyst for use in a fuel cell and a method of preparing the electrocatalyst thereof.

### BACKGROUND OF THE INVENTION

Fuel cell has been considered as an environmentally clean, economical and efficient alternative energy source which has been attracting growing attentions from the government, industrial and also academic sectors. A fuel cell is a device which generates electricity from a fuel and an oxidant during a chemical reaction. An electrochemical fuel cell generally includes an anode electrode and a cathode electrode separated by an electrolyte. A very well known example of fuel cell is Proton Exchange Membrane Fuel Cells (PEMFCs), in which hydrogen is used as fuel. However, in view of the high costs and storage considerations of pure hydrogen as required by the PEMFCs, attempts have been made to develop fuel cells which use fuel other than pure hydrogen, for example, Direct Methanol Fuel Cells (DMFCs) in which methanol is used as fuel. The DMFCs has been widely adopted in different applications including automotives.

However, traditional anode electrocatalysts for the DMFCs, for example, platinum (Pt) metal or platinum alloys, are known to encounter practical problems. For example, the performance of the Pt catalysts are very sensitive to impurities, with their catalytic activity being significantly reduced by the presence of even a very minute amount of carbon monoxide (CO), which is a by-product of the reaction of the fuel cell. Other disadvantages are that the traditional anode electrocatalysts are known to have very low electrocatalytic activity with poor durability. These drawbacks have significantly affected the efficiency and thus the performance of the DMFCs.

### SUMMARY OF THE INVENTION

According to a first aspect of the present invention, there is provided an electrocatalyst for a fuel cell comprising a substrate, a first metal compound, an active component and a second metal compound, wherein the first metal compound and the active component are deposited onto the substrate to form a first metal compound-active component deposited substrate, and the second metal compound is further deposited to and substantially encases the first metal compound-active component deposited substrate.

In an embodiment of the first aspect, the substrate includes a carbon material.

In an embodiment of the first aspect, the carbon material includes carbon nanotubes.

In an embodiment of the first aspect, the first metal compound includes a first metal oxide.

In an embodiment of the first aspect, the second metal compound includes a second metal oxide

In an embodiment of the first aspect, the first metal oxide includes ruthenium oxide.

In an embodiment of the first aspect, the active component includes a noble metal.

In an embodiment of the first aspect, the noble metal includes platinum.

In an embodiment of the first aspect, the platinum is in the form of particle.

In an embodiment of the first aspect, the second metal oxide includes manganese dioxide.

In an embodiment of the first aspect, the first metal oxide forms a first metal oxide layer on the substrate.

In an embodiment of the first aspect, the active component deposits on the first metal oxide layer.

In an embodiment of the first aspect, the second metal oxide forms a second metal oxide layer on and substantially encases the first metal compound and the active component.

In an embodiment of the first aspect, the substrate includes carbon nanotubes and the first metal compound includes a ruthenium containing compound, wherein the carbon nanotubes and the ruthenium are in a mass ratio of 1:0.02 to 0.15.

In an embodiment of the first aspect, the carbon nanotubes and the ruthenium are in a mass ratio of 1:0.04 to 0.12.

In an embodiment of the first aspect, the active component includes platinum, wherein the ruthenium and the platinum are in a mass ratio of 1:0.5 to 2.

In an embodiment of the first aspect, the ruthenium and the platinum are in a mass ratio of 1:1 to 1.5.

In an embodiment of the first aspect, the second metal compound includes a manganese containing compound, wherein the ruthenium and the manganese are in a mass ratio of 1:0.5 to 3.

In an embodiment of the first aspect, the ruthenium and the manganese are in a mass ratio of 1:1 to 2.5.

According to a second aspect of the present invention, there is provided a method of preparing an electrocatalyst for a fuel cell comprising the steps of depositing a first metal compound on a substrate to form a first metal compound-substrate composite, depositing an active component on the first metal compound-substrate composite to form an active-first metal compound-substrate composite, coating a second metal compound to substantially encase the active-first metal compound-substrate composite to form the electrocatalyst.

In an embodiment of the second aspect, the substrate includes a carbon material, the first metal compound includes a first metal oxide, the active component includes a noble metal, and the second metal compound includes a second metal oxide.

In an embodiment of the second aspect, the first metal oxide includes ruthenium oxide.

In an embodiment of the second aspect, the noble metal includes platinum.

In an embodiment of the second aspect, the second metal oxide includes manganese dioxide.

In an embodiment of the second aspect, the carbon material includes carbon nanotubes.

In an embodiment of the second aspect, the step of depositing a first metal compound on a substrate to form a first metal compound-substrate composite further comprises the steps of dispersing the substrate into a solution containing a first metal salt to form a dispersion, adding a first reagent to the dispersion, and refluxing the dispersion at a temperature ranged from about 60° C. to 100° C. for about 3 to 6 hours.

In an embodiment of the second aspect, the first metal salt includes a salt of ruthenium, the substrate and the ruthenium are at a mass ratio of about 1:0.02 to 0.15.

In an embodiment of the second aspect, the substrate and the ruthenium are at a mass ratio of about 1:0.04 to 0.12.

In an embodiment of the second aspect, the first reagent is hydrogen peroxide.

In an embodiment of the second aspect, further including a step of sonicating the dispersion prior to the step of adding a first reagent to the dispersion.

In an embodiment of the second aspect, the hydrogen peroxide is at a concentration of about 0.3 mL to 0.6 mL per mg of the ruthenium.

In an embodiment of the second aspect, the first metal salt includes ruthenium trichloride.

In an embodiment of the second aspect, the step of depositing an active component on the first metal compound-substrate composite to form an active-first metal compound-substrate composite further comprises steps of dispersing the first metal compound-substrate composite into a solvent to form a first suspension, adding a platinum containing compound to the first suspension, and refluxing the first suspension at a temperature from about 90° C. to 140° C. for 1.5 to 4.5 hours.

In an embodiment of the second aspect, the solvent includes ethylene glycol.

In an embodiment of the second aspect, the first metal oxide includes an oxide of ruthenium, the ruthenium, the platinum and the solvent are at a mass ratio of about 1:0.5 to 2:200 to 300.

In an embodiment of the second aspect, the ruthenium and the platinum are at a mass ratio of about 1:1 to 1.5.

In an embodiment of the second aspect, the platinum containing compound includes chloroplatinic acid.

In an embodiment of the second aspect, further including a step of adjusting pH of the first suspension to a pH range of about 6.5 to 9.5 prior to the step of refluxing the first suspension at a temperature from about 90° C. to 140° C. for 1.5 to 4.5 hours.

In an embodiment of the second aspect, the step of coating a second metal compound to substantially encase the active-first metal compound-substrate composite to form the electrocatalyst further comprises the steps of dispersing the active-first metal compound-substrate composite in a manganese salt containing solution to form a second suspension, adding a second reagent into the second suspension, and refluxing the second suspension at a temperature from about 60° C. to 100° C. for about 2.5 to 5 hours.

In an embodiment of the second aspect, the second reagent includes citric acid.

In an embodiment of the second aspect, the first metal oxide includes an oxide of ruthenium and the manganese salt includes a salt of manganese, the ruthenium, the manganese and the citric acid are at a mass ratio of about 1:0.5 to 3:1 to 6.

In an embodiment of the second aspect, the ruthenium and the manganese are at a mass ratio of about 1:1 to 2.5.

In an embodiment of the second aspect, the platinum is in the form of platinum particle.

### BRIEF DESCRIPTION OF THE DRAWINGS

FIG. 1 shows the transmission electron micrograph (TEM) of the prepared MnO₂/Pt/RuO₂/CNTs composite in accordance with the second embodiment of the present invention;

FIG. 2 shows the effect of MnO₂ loading of the MnO₂/Pt/RuO₂/CNTs composite to the methanol oxidation activity;

FIG. 3 shows the average particle size of the Pt particle of the Pt/RuO₂/CNTs composite (above) and the MnO₂/Pt/RuO₂/CNTs composite (below);

FIG. 4 shows the effect of RuO₂ loading of the MnO₂/Pt/RuO₂/CNTs composite to the methanol oxidation activity;

FIG. 5 shows the voltammogram of the methanol oxidation with the MnO₂/Pt/RuO₂/CNTs catalyst prepared in accordance with the third embodiment of the present invention;

FIG. 6 shows the durability of the MnO₂/Pt/RuO2/CNTs catalyst prepared in accordance with the fourth embodiment of the present invention to methanol oxidation.

### DESCRIPTION OF THE PREFERRED EMBODIMENTS

Without wishing to be bound by theory, the inventor through trials, research, study and observations is of the opinion that the present application has numerous advantages. As a starting point in the consideration of anode electrocatalyst for a fuel cell, the inventor noticed that methods have been developed to enhance the CO tolerance of the electrocatalyst, and to promote the durability of the electrocatalyst. For example, it is disclosed in Chinese Patents No. CN1171671C, CN1221050C and CN1123080C, and Chinese Patent Applications No. CN1601788 and CN1827211 that anode electrocatalysts comprising platinum (Pt), ruthenium (Ru), and a number of other metals and metal oxides have been developed. However, only the use of Ru metal has been disclosed. It is also disclosed in Chinese Patent Application No. CN102101056A that an anode electrocatalyst can be prepared by using one or more oxides of the following metals including titanium (Ti), zirconium (Zr), vanadium (V), chromium (Cr), molybdenum (Mo), tungsten (W), manganese (Mn), cobalt (Co), nickel (Ni) and silicone (Si), immobilizing the metal oxides onto a carbon carrier, and depositing active components onto the metal oxides. It is further disclosed in Chinese Patent Application No. CN200710030647.9, which is an application made by the applicant of the present application that, an anode electrocatalyst can be prepared by immobilizing ruthenium oxide (RuO₂) onto carbon nanotubes (CNTs) to form a RuO₂/CNTs compound, and further depositing Pt onto the RuO₂/CNTs compound to form a Pt/RuO2/CNTs catalyst. It is discussed in the patent application that the RuO₂ component of the Pt/RuO₂/CNTs catalyst assists in enhancing the CO tolerance of the catalyst, and improves the dispersion of Pt over the CNTs. However, the Pt/RuO₂/CNTs catalyst is of poor durability due to the dissolution of the RuO₂ and Pt components from the Pt/RuO₂/CNTs catalyst in practice.

By way of example only, embodiments of the present invention are described more fully hereinafter with reference to the accompanying drawings. However, the scope of protection of the present invention is not limited by them.

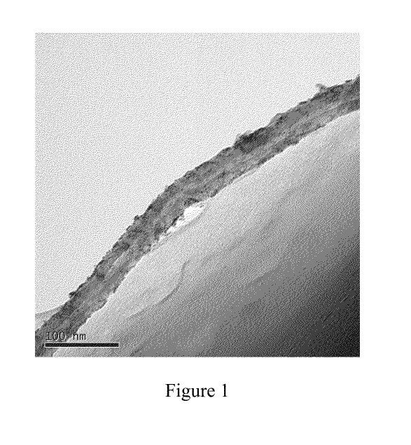

FIG. 1 shows an anode electrocatalyst for direct methanol fuel cells (DMFCs) according to an embodiment of the present invention. Specifically, the anode electrocatalyst comprises a substrate, a first metal compound, an active component and a second metal compound, wherein the first metal compound and the active component are deposited onto the substrate to form a first metal compound-active component deposited substrate, and the second metal compound is further deposited to and substantially encases the first metal compound-active component deposited substrate.

The substrate serves as a support for the first metal compound, the active, catalytic component and the second metal compound. Preferably, the substrate includes a carbon material for its chemical and thermal stability, and more preferably, the substrate includes carbon nanotubes (CNTs) for their increased surface area and improved mechanical strength and conductivity. The carbon nanotubes can be of a dimension ranged from about 20 nm to 40 nm, and of a length ranged from 5 μm to 15 μm.

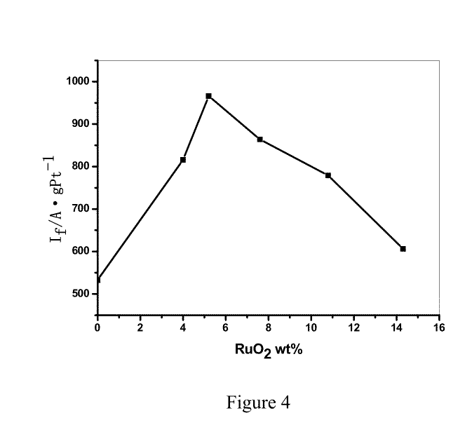

The first metal compound is deposited on the surface of the substrate. The first metal compound can be a metal oxide, which is selected from a group consisting of ruthenium oxide (RuO₂), tin dioxide (SnO₂), iridium oxide (IrO₂), molybdenum oxide (MoO₂) and a mixture thereof. Preferably, the metal oxide is a ruthenium oxide (RuO₂). Preferably, the RuO₂ forms a layer on the surface of the carbon nanotubes to form RuO₂/CNTs composites. RuO₂ provides oxygen-carrying species such as hydroxyl (OH) which improve the carbon monoxide (CO) oxidation ability of the electrocatalyst. RuO₂ also provides further nucleating sites for nucleation of the active component such as platinum and consequently improves dispersion of the active component of the catalyst. In addition, RuO₂ assists in the transmission of electrons to the CNTs and then to the external circuit. FIG. 4 shows the effect of the RuO₂ loading to methanol oxidation activity. For an optimum catalytic activity, the mass ratio of the carbon nanotubes to ruthenium is of about 1:0.02 to 0.15, preferably, about 1:0.04 to 0.12.

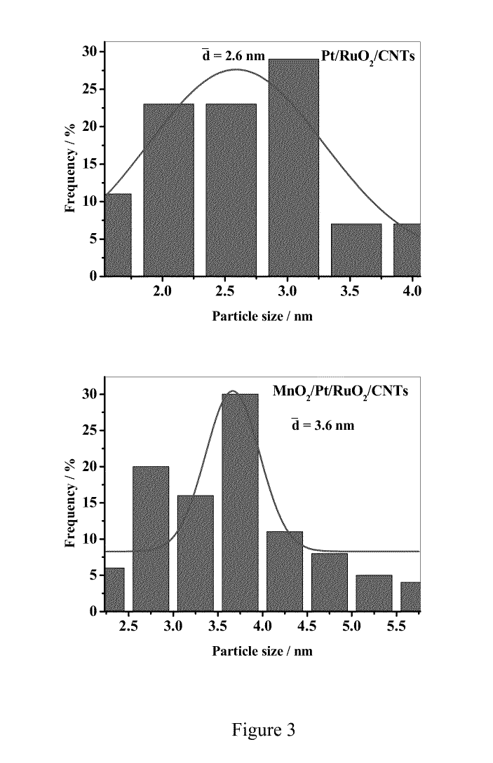

The active component, which catalyses the oxidation of methanol in the fuel cell, is further deposited on the RuO₂ layer of the RuO₂/CNTs composites to form Pt/RuO₂/CNTs composites. The active component can be a noble metal, preferably, platinum (Pt). More preferably, the platinum is in the form of platinum particles with size ranged from about 2.5 nm to about 4.0 nm in average diameter. FIG. 3 shows the average diameter of the platinum particles supported on the RuO₂/CNTs composites (above) and the platinum particles supported on the RuO₂/CNTs composites after coating by the MnO₂ (below). The present of the RuO₂ layer assists in providing more nucleating sites for the formation of platinum particles with better dispersion. The platinum particles can be replaced by particles of other noble metal, for example, Palladium (Pd). However, it is known that Pd exhibits a lower methanol oxidation activity than Pt. The ruthenium of the RuO₂ layer on the substrate and the platinum deposited thereon are of a mass ratio of about 1:0.5 to 2, preferably, about 1:1 to 1.5.

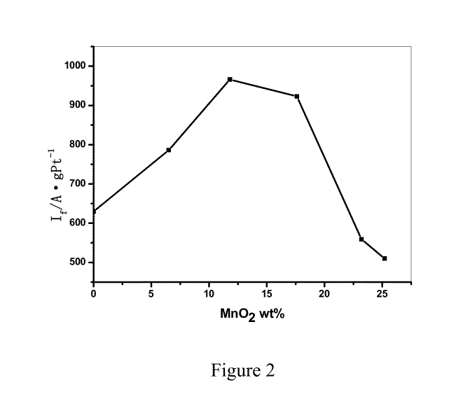

The second metal compound is further deposited onto the surface of the Pt/RuO₂/CNTs composites. The second metal compound can be a metal oxide, and preferably, manganese dioxide (MnO₂). The MnO₂ forms a layer to substantially cover or encase the Pt/RuO₂/CNTs composites to form the MnO₂/Pt/RuO₂/CNTs catalysts. The term “substantially cover or encase” does not necessary refer to an absolute, 100% coverage or encapsulation of the Pt/RuO₂/CNTs composites. Instead, a person skilled in this relevant field would understand that means coverage in a significant extent so as to provide an enhancement of durability of the catalyst by preventing dissolution of the Pt and RuO₂ from the CNTs, and at the same time, improve proton conductivity. The extent of MnO₂ coverage on the Pt/RuO₂/CNTs catalysts can be quantified by the loading amount of MnO₂ on to the catalysts. FIG. 2 shows the effect of MnO₂ loading to the methanol oxidation activity of the catalysts. For an optimum catalytic activity, the mass ratio of ruthenium of the RuO₂ to manganese of the MnO₂ is of about 1:0.5 to 3, preferably, about 1:1 to 2.5.

In preparing the MnO₂/Pt/RuO₂/CNTs electrocatalysts, the RuO₂ is firstly deposited on the CNTs to form RuO₂/CNTs composites. Pt is then deposited further onto the RuO₂/CNTs composites. Finally, MnO₂ is coated onto the surface of, and substantially encases the Pt/RuO₂/CNTs composites to form the MnO₂/Pt/RuO₂/CNTs catalysts.

Specifically, carbon nanotubes (CNTs) are first dispersed in an aqueous solution containing ruthenium salt, for example, ruthenium trichloride solution by sonication. Preferably, the mass ratio of CNTs to ruthenium is in the range of about 1:0.02 to 0.15, more preferably, about 1:0.04 to 0.12, and the sonication time is from about 0.5 to 3 hours. An oxidizing agent, preferably, hydrogen peroxide solution (30 vol %), is added dropwise with a speed from 9 to 20 mL/hour to the dispersion. The ratio of the volume of hydrogen peroxide (30 vol %) to the ruthenium mass is ranged from about 1.0 mL/mg to 2.0 mL/mg (i.e. 0.3 mL to 0.6 mL of hydrogen peroxide per mg of ruthenium). The dispersion is then refluxed at the temperature from 60° C. to 100° C. for 3 to 6 hours. After filtration, washing and drying at the temperature from 90° C. to 130° C., ruthenium dioxide (RuO₂) supported or immobilized on CNTs (RuO₂/CNTs composites) is prepared. Preferably, the optimum mass ratio of CNTs to ruthenium lies in the range of about 1:0.04 to 0.12.

The RuO₂/CNTs composites are further dispersed into a solvent, for example, ethylene glycol to form a suspension. A platinum containing compound, for example, chloroplatinic acid, is then added to the suspension, with the mass ratio of ruthenium to platinum to ethylene glycol in the range of about 1:0.5 to 2:200 to 300. The pH value of the suspension is adjusted to the range of about pH 6.5 to 9.5 and then the suspension is heated refluxed at the temperature range of about 90° C. to 140° C. for 1.5 hours to 4.5 hours. By filtration, washing and drying at the temperature range of about 60° C. to 80° C., platinum particles supported on RuO₂/CNTs (i.e. Pt/RuO₂/CNTs composites) are obtained. Preferably, the optimum mass ratio of ruthenium to platinum is in the range of about 1:1 to 1.5.

The Pt/RuO₂/CNTs composites are then dispersed in deionized water by sonication, with an addition of potassium permanganate solution to form a suspension. Citric acid solution is then added dropwise into the suspension, with the mass ratio of ruthenium to manganese to citric acid being about 1:0.5 to 3:1 to 6. The suspension is then heated refluxed at the temperature range of about 60° C. to 100° C. for 2.5 hours to 5 hours. After filtration, washing and drying at the temperature range of 60° C. to 80° C., manganese dioxide is coated on the Pt/RuO₂/CNTs composites to form MnO₂/Pt/RuO₂/CNTs catalysts. Preferably, the optimum mass ratio of ruthenium to manganese is in the range of about 1:1 to 2.5.

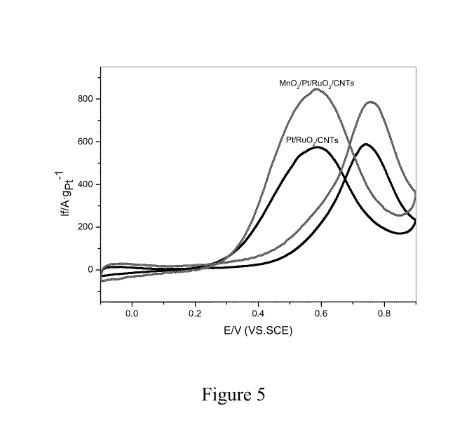

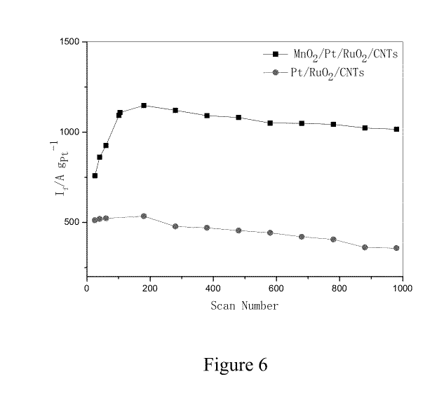

In one embodiment, advantages of the present invention is provided by at least having hydrous RuO₂ immobilized on CNTs, and then with Pt salts reduced to form Pt particles which are deposited on the RuO₂/CNTs composites, with ethylene glycol being used as solvent and reductant. With more nuclei sites being provided by the hydrous RuO₂, the Pt particles are allowed to disperse more uniformly onto the CNTs. The uniformly dispersed Pt particles provide an increase in electroactive surface area which leads to a significantly improved electrocatalytic activity towards methanol oxidation. In addition, the coating or covering of MnO₂ onto the surface of the Pt/RuO₂/CNTs composites prevents the dissolution of the Pt particles, RuO₂ from the catalysts and even the damage of CNTs which leads to the loss of electrocatalytic activity, and at the same time, improves proton transport to enhance the oxidation reaction of methanol and thus the efficiency of the electrocatalysts. Furthermore, RuO₂ improves the CO tolerance and MnO₂ improves the durability and also proton transport capability of the catalysts. The electrocatalysts exhibit an excellent performance in methanol electro-oxidation, showing a peak current up to 783 A/g Pt and the onset potential for CO oxidation as low as 0.3 V (vs. Ag/AgCl) (FIG. 5), with 88% of its original activity maintained after 1000 cyclic scans (FIG. 6).

### Embodiment 1

Step 1: Carbon nanotubes (CNTs) are dispersed in aqueous ruthenium trichloride solution by sonication, in which the mass ratio of CNTs to ruthenium is in the range of 1:0.02 and the sonication time is 0.5 hour. Hydrogen peroxide (30 vol %) is dropwise added with the droping speed of 9 mL/h and the ratio of the volume of hydrogen peroxide (30 vol %) to the ruthenium mass of 1 mL: 1 mg. The suspension was refluxed at the temperature of 60° C. for 3 hours. After filtration, washing and drying at the temperature of 90° C., ruthenium dioxide supported CNTs (RuO₂/CNTs composites) are derived.

Step 2: RuO₂/CNTs are dispersed into ethylene glycol with the addition of chloroplatinic acid, in which the mass ratio of ruthenium to platinum to ethylene glycol is 1:0.5:200. The pH value of the suspension is adjusted to 6.5 and then the suspension is heated refluxed at the temperature of 90° C. for 1.5 hours. By filtration, washing and drying at the temperature of 60° C., platinum nanoparticles supported RuO₂/CNTs (Pt/RuO₂/CNTs composites) are obtained.

Step 3: Pt/RuO₂/CNTs are dispersed in deionized water by sonication with addition of potassium permanganate solution. Citric acid solution is dropwise added into the suspension with the mass ratio of ruthenium to manganese to citric acid of 1:0.5:1. The suspension is heated refluxed at the temperature of 60° C. for 2.5 hours. After filtration, washing and drying at the temperature of 60° C., manganese dioxide covered Pt/RuO₂/CNTs (MnO₂/Pt/RuO₂/CNTs composites) are derived.

### Embodiment 2

Step 1: Carbon nanotubes (CNTs) are dispersed in aqueous ruthenium trichloride solution by sonication, in which the mass ratio of CNTs to ruthenium is in the range of 1:0.04 and the sonication time is 1 hour. Hydrogen peroxide (30 vol %) is dropwise added with the droping speed of 12 mL/h and the ratio of the volume of hydrogen peroxide (30 vol %) to the ruthenium mass of 1.3 mL: 1 mg. The suspension was refluxed at the temperature of 80° C. for 4 hours. After filtration, washing and drying at the temperature of 100° C., ruthenium dioxide supported CNTs (RuO₂/CNTs composite) are derived.

Step 2: RuO₂/CNTs is dispersed into ethylene glycol with the addition of chloroplatinic acid, in which the mass ratio of ruthenium to platinum to ethylene glycol is 1:1:250. The pH value of the suspension is adjusted to 8 and then the suspension is heated refluxed at the temperature of 130° C. for 2 hours. By filtration, washing and drying at the temperature of 70° C., platinum nanoparticles supported RuO₂/CNTs (Pt/RuO₂/CNTs composites) are obtained.

Step 3: Pt/RuO₂/CNTs is dispersed in deionized water by sonication with addition of potassium permanganate solution. Citric acid solution is dropwise added into the suspension with the mass ratio of ruthenium to manganese to citric acid of 1:1:2.6. The suspension is heated refluxed at the temperature of 80° C. for 4 hours. After filtration, washing and drying at the temperature of 70° C., manganese dioxide covered Pt/RuO₂/CNTs (MnO₂/Pt/RuO₂/CNTs composite) are derived.

FIG. 1 shows the TEM picture of the prepared MnO₂/Pt/RuO₂/CNTs catalyst, which revealed an uniform dispersion of the Pt particles on the CNTs. The average diameter of the Pt particles is of about 2 to 3 nm.

### Embodiment 3

Step 1: Carbon nanotubes (CNTs) are dispersed in aqueous ruthenium trichloride solution by sonication, in which the mass ratio of CNTs to ruthenium is in the range of 1:0.08 and the sonication time is 2 hour. Hydrogen peroxide (30 vol %) is added dropwise with a droping speed of 15 mL/h and the ratio of the volume of hydrogen peroxide (30 vol %) to the ruthenium mass of 1.5 mL: 1 mg. The suspension was refluxed at the temperature of 85° C. for 4.5 hours. After filtration, washing and drying at the temperature of 110° C., ruthenium dioxide supported CNTs (RuO₂/CNTs composite) are derived.

Step 2: RuO₂/CNTs is dispersed into ethylene glycol with the addition of chloroplatinic acid, in which the mass ratio of ruthenium to platinum to ethylene glycol is 1:1.2:270. The pH value of the suspension is adjusted to 8.5 and then the suspension is heated refluxed at the temperature of 135° C. for 2.5 hours. By filtration, washing and drying at the temperature of 75° C., platinum nanoparticles supported RuO₂/CNTs (Pt/RuO₂/CNTs composite) are obtained.

Step 3: Pt/RuO₂/CNTs are dispersed in deionized water by sonication with addition of potassium permanganate solution. Citric acid solution is added dropwise into the suspension with the mass ratio of ruthenium to manganese to citric acid of 1:1.8:4.5. The suspension is heated refluxed at the temperature of 85° C. for 3.5 hours. After filtration, washing and drying at the temperature of 75° C., manganese dioxide covered Pt/RuO₂/CNTs (MnO₂/Pt/RuO₂/CNTs) are derived.

The voltammogram of the prepared MnO₂/Pt/RuO₂/CNTs composite and Pt/RuO₂/CNTs composite (for comparison) for methanol oxidation is shown in FIG. 5. It can be seen that the MnO₂/Pt/RuO₂/CNTs composite as prepared in this embodiment shows higher catalytic activity for methanol (peak current of 783 A/g Pt) than of the Pt/RuO₂/CNTs composite (peak current of 584 A/g Pt).

### Embodiment 4

Step 1: Carbon nanotubes (CNTs) are dispersed in aqueous ruthenium trichloride solution by sonication, in which the mass ratio of CNTs to ruthenium is in the range of 1:0.04 and the sonication time is 2.5 hour. Hydrogen peroxide (30 vol %) is added dropwise with a droping speed of 18 mL/h and the ratio of the volume of hydrogen peroxide (30 Vol %) to the ruthenium mass of 1.8 mL: 1 mg. The suspension was refluxed at the temperature of 90° C. for 5 hours. After filtration, washing and drying at the temperature of 120° C., ruthenium dioxide supported CNTs (RuO₂/CNTs composite) are derived.

Step 2: RuO₂/CNTs is dispersed into ethylene glycol with the addition of chloroplatinic acid, in which the mass ratio of ruthenium to platinum to ethylene glycol is 1:1.5:280. The pH value of the suspension is adjusted to pH 8.6 and then the suspension is heated refluxed at the temperature of 140° C. for 2 hours. By filtration, washing and drying at the temperature of 70° C., platinum nanoparticles supported RuO₂/CNTs (Pt/RuO₂/CNTs composite) are obtained.

Step 3: Pt/RuO₂/CNTs is dispersed in deionized water by sonication with addition of potassium permanganate solution. Citric acid solution is added dropwise into the suspension with the mass ratio of ruthenium to manganese to citric acid of 1:2.5:5.5. The suspension is heated refluxed at the temperature of 90° C. for 4.5 hours. After filtration, washing and drying at the temperature of 70° C., manganese dioxide covered Pt/RuO₂/CNTs (MnO₂/Pt/RuO₂/CNTs composite) are derived.

The durability of the prepared MnO₂/Pt/RuO₂/CNTs composite and Pt/RuO₂/CNTs composite (for comparison) for methanol oxidation is shown in FIG. 6. It can be seen that the MnO₂/Pt/RuO₂/CNTs composite as prepared in this embodiment exhibits excellent durability with 88% of its original activity maintained after 1000 cyclic scans. While the Pt/RuO₂/CNTs composite keeps only 67% of its original activity after 1000 cyclic scans.

### Embodiment 5

Step 1: Carbon nanotubes (CNTs) are dispersed in aqueous ruthenium trichloride solution by sonication, in which the mass ratio of CNTs to ruthenium is in the range of 1:0.12 and the sonication time is 3 hour. Hydrogen peroxide (30 vol %) is added dropwise with the droping speed of 13 mL/h and the ratio of the volume of hydrogen peroxide (30 vol %) to the ruthenium mass of 1.6 mL: 1 mg. The suspension was refluxed at the temperature of 80° C. for 4 hours. After filtration, washing and drying at the temperature of 110° C., ruthenium dioxide supported CNTs (RuO₂/CNTs composite) are derived.

Step 2: RuO₂/CNTs is dispersed into ethylene glycol with the addition of chloroplatinic acid, in which the mass ratio of ruthenium to platinum to ethylene glycol is 1:1.5:300. The pH value of the suspension is adjusted to 8.4 and then the suspension is heated refluxed at the temperature of 140° C. for 2.5 hours. By filtration, washing and drying at the temperature of 70° C., platinum nanoparticles supported RuO₂/CNTs (Pt/RuO₂/CNTs composite) are obtained.

Step 3: Pt/RuO₂/CNTs is dispersed in deionized water by sonication with addition of potassium permanganate solution. Citric acid solution is dropwise added into the suspension with the mass ratio of ruthenium to manganese to citric acid of 1:2.5:5. The suspension is heated refluxed at the temperature of 80° C. for 4 hours. After filtration, washing and drying at the temperature of 70° C., manganese dioxide covered Pt/RuO₂/CNTs (MnO₂/Pt/RuO₂/CNTs composite) are derived.

### Embodiment 6

Step 1: Carbon nanotubes (CNTs) are dispersed in aqueous ruthenium trichloride solution by sonication, in which the mass ratio of CNTs to ruthenium is in the range of 1:0.15 and the sonication time is 3 hour. Hydrogen peroxide (30 vol %) is added dropwise with the droping speed of 20 mL/h and the ratio of the volume of hydrogen peroxide (30 vol %) to the ruthenium mass of 2 mL: 1 mg. The suspension was refluxed at the temperature of 100° C. for 6 hours. After filtration, washing and drying at the temperature of 130° C., ruthenium dioxide supported CNTs (RuO₂/CNTs composite) are derived.

Step 2: RuO₂/CNTs are dispersed into ethylene glycol with the addition of chloroplatinic acid, in which the mass ratio of ruthenium to platinum to ethylene glycol is 1:2:300. The pH value of the suspension is adjusted to 9.5 and then the suspension is heated refluxed at the temperature of 140° C. for 4.5 hours. By filtration, washing and drying at the temperature of 80° C., platinum nanoparticles supported RuO₂/CNTs (Pt/RuO₂/CNTs) are obtained.

Step 3: Pt/RuO₂/CNTs is dispersed in deionized water by sonication with addition of potassium permanganate solution. Citric acid solution is added dropwise into the suspension with the mass ratio of ruthenium to manganese to citric acid of 1:3:6. The suspension is heated refluxed at the temperature of 100° C. for 5 hours. After filtration, washing and drying at the temperature of 80° C., manganese dioxide covered Pt/RuO₂/CNTs (MnO₂/Pt/RuO₂/CNTs composite) are derived.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided or separately or in any suitable subcombination.

1. An electrocatalyst for a fuel cell, comprising:
a substrate, a first metal compound, an active component and a second metal compound, wherein the first metal compound and the active component are deposited onto the substrate to form a first metal compound-active component deposited substrate, and the second metal compound is further deposited to and substantially encases the first metal compound-active component deposited substrate.

2. The electrocatalyst according to claim 1, wherein the substrate includes a carbon material.

3. The electrocatalyst according to claim 2, wherein the carbon material includes carbon nanotubes.

4. The electrocatalyst according to claim 1, wherein the first metal compound includes a first metal oxide.

5. The electrocatalyst according to claim 1, wherein the second metal compound includes a second metal oxide

6. The electrocatalyst according to claim 4, wherein the first metal oxide includes ruthenium oxide.

7. The electrocatalyst according to claim 1, wherein the active component includes a noble metal.

8. The electrocatalyst according to claim 7, wherein the noble metal includes platinum.

9. The electrocatalyst according to claim 8, wherein the platinum is in the form of particle.

10. The electrocatalyst according to claim 5, wherein the second metal oxide includes manganese dioxide.

11. The electrocatalyst according to claim 4, wherein the first metal oxide forms a first metal oxide layer on the substrate.

12. The electrocatalyst according to claim 11, wherein the active component deposits on the first metal oxide layer.

13. The electrocatalyst according to claim 5, wherein the second metal oxide forms a second metal oxide layer on and substantially encases the first metal compound and the active component.

14. The electrocatalyst according to claim 1, wherein the substrate includes carbon nanotubes and the first metal compound includes a ruthenium containing compound, wherein the carbon nanotubes and the ruthenium are in a mass ratio of 1:0.02 to 0.15.

15. The electrocatalyst according to claim 14, wherein the carbon nanotubes and the ruthenium are in a mass ratio of 1:0.04 to 0.12.

16. The electrocatalyst according to claim 14, wherein the active component includes platinum, wherein the ruthenium and the platinum are in a mass ratio of 1:0.5 to 2.

17. The electrocatalyst according to claim 16, wherein the ruthenium and the platinum are in a mass ratio of 1:1 to 1.5.

18. The electrocatalyst according to claim 14 wherein the second metal compound includes a manganese containing compound, wherein the ruthenium and the manganese are in a mass ratio of 1:0.5 to 3.

19. The electrocatalyst according to claim 18, wherein the ruthenium and the manganese are in a mass ratio of 1:1 to 2.5.

20. A method of preparing an electrocatalyst for a fuel cell, comprising the steps of:
(a) depositing a first metal compound on a substrate to form a first metal compound-substrate composite,
(b) depositing an active component on the first metal compound-substrate composite to form an active-first metal compound-substrate composite,
(c) coating a second metal compound to substantially encase the active-first metal compound-substrate composite to form the electrocatalyst,

21. The method according to claim 20, wherein the substrate includes a carbon material, the first metal compound includes a first metal oxide, the active component includes a noble metal, and the second metal compound includes a second metal oxide.

22. The method according to claim 21, wherein the first metal oxide includes ruthenium oxide.

23. The method according to claim 21, wherein the noble metal includes platinum.

24. The method according to claim 21, wherein the second metal oxide includes manganese dioxide.

25. The method according to claim 21, wherein the carbon material includes carbon nanotubes.

26. The method according to claim 21, wherein step (a) further comprises the steps of:
(i) dispersing the substrate into a solution containing a first metal salt to form a dispersion,
(ii) adding a first reagent to the dispersion,
(iii) refluxing the dispersion at a temperature ranged from about 60° C. to 100° C. for about 3 to 6 hours.

27. The method according to claim 26, wherein the first metal salt includes a salt of ruthenium, the substrate and the ruthenium are at a mass ratio of about 1:0.02 to 0.15.

28. The method according to claim 27, wherein the substrate and the ruthenium are at a mass ratio of about 1:0.04 to 0.12.

29. The method according to claim 26, wherein the first reagent is hydrogen peroxide.

30. The method according to claim 26, further including a step of sonicating the dispersion prior to step (ii).

31. The method according to claim 29, wherein the hydrogen peroxide is at a concentration of about 0.3 mL to 0.6 mL per mg of the ruthenium.

32. The method according to claim 26, wherein the first metal salt includes ruthenium trichloride.

33. The method according to claim 20, wherein step (b) further comprises the steps of:
(iv) dispersing the first metal compound-substrate composite into a solvent to form a first suspension,
(v) adding a platinum containing compound to the first suspension,
(vi) refluxing the first suspension at a temperature from about 90° C. to 140° C. for 1.5 to 4.5 hours.

34. The method according to claim 39, wherein the solvent includes ethylene glycol.

35. The method according to claim 34, wherein the first metal oxide includes an oxide of ruthenium, the ruthenium, the platinum and the solvent are at a mass ratio of about 1:0.5 to 2:200 to 300.

36. The method according to claim 35, wherein the ruthenium and the platinum are at a mass ratio of about 1:1 to 1.5.

37. The method according to claim 33, wherein the platinum containing compound includes chloroplatinic acid.

38. The method according to claim 33, further including a step of adjusting pH of the first suspension to a pH range of about 6.5 to 9.5 prior to step (vi).

39. The method according to claim 24, wherein step (c) further comprises the steps of:
(vii) dispersing the active-first metal compound-substrate composite in a manganese salt containing solution to form a second suspension,
(viii) adding a second reagent into the second suspension of step (vii),
(ix) refluxing the second suspension of step (viii) at a temperature from about 60° C. to 100° C. for about 2.5 to 5 hours.

40. The method according to claim 39, wherein the second reagent include citric acid.

41. The method according to claim 40, wherein the first metal oxide includes an oxide of ruthenium and the manganese salt includes a salt of manganese, the ruthenium, the manganese and the citric acid are at a mass ratio of about 1:0.5 to 3:1 to 6.

42. The method according to claim 41, wherein the ruthenium and the manganese are at a mass ratio of about 1:1 to 2.5.

43. The method according to claim 23, wherein the platinum is in the form of platinum particle.
